(19) United States
(12) Patent Application Publication
(10) Pub. No.: US 2022/0126329 A1
(43) Pub. Date: Apr. 28, 2022

(54) PRESSURE SHUTOFF VALVE FOR A PRESSURE WASHER AND PRESSURE WASHER WITH A PRESSURE SHUTOFF VALVE

(71) Applicant: Andreas Stihl AG & Co. KG, Waiblingen (DE)

(72) Inventors: Klaus Kaupp, Waiblingen (DE); Stefan Schlanderer, Kernen (DE)

(21) Appl. No.: 17/508,672

(22) Filed: Oct. 22, 2021

(30) Foreign Application Priority Data
Oct. 26, 2020 (EP) 20 203 837.8

(51) Int. Cl. B08B 3/02

(52) U.S. Cl. CPC B08B 3/028; B08B 2203/027

(57) ABSTRACT

The disclosure relates to a pressure shutoff valve for a pressure washer. The pressure shutoff valve has an effective throttle gap with an overall length (a), as measured in the direction of the longitudinal axis of the valve body, between the valve housing and the valve body, wherein the effective throttle gap is part of the flow connection between the inlet and the outlet. The valve body has a maximum diameter (d) extending radially with respect to the longitudinal axis. The overall length (a) of the effective throttle gap is at least 50% of the maximum diameter (d) of the valve body in the first closed position of the pressure shutoff valve.

### CROSS REFERENCE TO RELATED APPLICATION

This application claims priority of European patent application no. 20 203 837.8, filed Oct. 26, 2020, the entire content of which is incorporated herein by reference.

### TECHNICAL FIELD

The disclosure relates to a pressure shutoff valve for a pressure washer and to a pressure washer with such a pressure shutoff valve.

### BACKGROUND

Pressure washers are used to pressurize a cleaning liquid, in particular water, and subsequently to eject same via a spray attachment, for example a lance with a nozzle head, and to clean objects with the liquid jet. In order to generate the pressure, the pressure washer has a pump which is connected at its inlet to an intake line and at its outlet to a pressure line. Liquid is supplied to the pump via the intake line. The liquid is pressurized by the pump and transferred from the outlet of the pump into the pressure line. If the spray attachment is opened, the liquid flows under high pressure out of the spray attachment. If the spray attachment is closed, the pump has to be deactivated in order to reduce the mechanical loading. For this purpose, a pressure shutoff valve is provided which, when a limit pressure is exceeded, actuates a switch for deactivating the pump.

A disadvantage of such pressure shutoff valves is that the pressure shutoff valves do not reliably switch and at the same time have high production costs.

### SUMMARY

It is an object of the disclosure to provide a pressure shutoff valve configured in such a manner that the robustness of the pressure shutoff valve is increased and at the same time the production costs thereof are reduced.

The aforementioned object can, for example, be achieved by a pressure shutoff valve for a pressure washer. The pressure shutoff valve includes: a valve housing having a valve seat; at least one inlet for supplying a liquid; at least one outlet for removing the liquid; a valve body defining a longitudinal axis; the valve body having a valve member assigned to the valve seat, wherein, in a first closed position of the pressure shutoff valve, the valve seat is closed by the valve member and a flow connection between the at least one inlet and the at least one outlet is interrupted; wherein the pressure shutoff valve has an effective throttle gap between the valve housing and the valve body; the effective throttle gap having an overall length (a) as measured in a direction of the longitudinal axis of the valve body; the effective throttle gap being part of the flow connection between the at least one inlet and the at least one outlet; the valve body having a maximum diameter (d) extending radially with respect to the longitudinal axis; and, the overall length (a) of the effective throttle gap being at least 50% of the maximum diameter (d) of the valve body in the first closed position of the pressure shutoff valve.

It is a further object of the disclosure to provide a pressure washer with a pressure shutoff valve configured in such a manner that the robustness of the pressure washer is increased and at the same time the production costs of the pressure washer are reduced.

This object can, for example, be achieved by a pressure washer including: a pressure shutoff valve including a valve housing having a valve seat; the pressure shutoff valve having at least one inlet for supplying a liquid and at least one outlet for removing the liquid; the pressure shutoff valve further having a valve body defining a longitudinal axis; the valve body having a valve member assigned to the valve seat, wherein, in a first closed position of the pressure shutoff valve, the valve seat is closed by the valve member and a flow connection between the at least one inlet and the at least one outlet is interrupted; the pressure shutoff valve having an effective throttle gap between the valve housing and the valve body; the effective throttle gap having an overall length (a) as measured in a direction of the longitudinal axis of the valve body; the effective throttle gap being part of the flow connection between the at least one inlet and the at least one outlet; the valve body having a maximum diameter (d) extending radially with respect to the longitudinal axis; and, the overall length (a) of the effective throttle gap being at least 50% of the maximum diameter (d) of the valve body in the first closed position of the pressure shutoff valve.

The pressure shutoff valve for a pressure washer includes a valve housing with a valve seat, at least one inlet for supplying a liquid, at least one outlet for removing the liquid, and a valve body with a longitudinal axis. The valve body has a valve member assigned to the valve seat, wherein, in a first closed position of the pressure shutoff valve, the valve seat is closed by the valve member and the flow connection between the inlet and the outlet is interrupted. The pressure shutoff valve has an effective throttle gap with an overall length, as measured in the direction of the longitudinal axis of the valve body, between the valve housing and the valve body, wherein the effective throttle gap is part of the flow connection between the inlet and the outlet. The valve body has a maximum diameter extending radially with respect to the longitudinal axis. The overall length of the effective throttle gap is at least 50% of the maximum diameter of the valve body in the first closed position of the pressure shutoff valve.

The disclosure is based on the finding that the lack of reliability of conventional pressure shutoff valves can be attributed to clogging of the throttle gap. Very small particles in the liquid collect in the pressure shutoff valve, preferably at the narrowest points, namely the throttle gap. These particles accumulate at the throttle gap, as a result of which the liquid can no longer flow unobstructed along the throttle gap. The switching properties of the valve are thereby changed.

The formation of a particularly long effective throttle gap between the valve body and the valve housing increases the flow resistance of the liquid through the pressure shutoff valve, as a result of which, in turn, an increased gap height of the throttle gap, which reduces the flow resistance, can be provided. Very fine particles no longer collect at the throttle gap, but rather are flushed out with the liquid. A high degree of robustness of the pressure shutoff valve is therefore ensured.

In order to achieve the small manufacturing tolerances for the comparatively narrow throttle gaps of conventional pressure shutoff valves, valve housing and valve body are produced from metal materials. A comparatively high gap height of the throttle gap enables greater manufacturing tolerances to be provided. Even plastics can thus be used for the valve body or the valve housing. It is even possible to dispense with finishing steps in the manufacturing of the components, as a result of which the production costs of the pressure shutoff valve and thus also of the pressure washer can be reduced.

It can advantageously be provided that the effective throttle gap has a gap height, as measured radially with respect to the longitudinal axis of the valve body, wherein the gap height is at most 0.25 mm, in particular at most 0.2 mm. It is provided in particular that the gap height is at least 0.05 mm, in particular at least 0.1 mm. The gap height is thus small enough to produce a sufficiently large flow resistance. In addition, the gap height is large enough to avoid small particles collecting at the throttle gap.

It can preferably be provided that the effective throttle gap includes a first throttle gap with a first diameter and a second throttle gap with a second diameter. Between the first throttle gap and the second throttle gap, an overflow chamber can preferably be provided between the valve body and the valve housing. If the pressure in the pressure line reaches a limit pressure, the valve body is pressed, in a second closed position of the pressure shutoff valve, against a switch element which deactivates the pump. In this second closed position, the flow connection is blocked by a seal present at the second throttle gap. Since in particular the pump, but also the entire hydraulic system, is subject to the mass inertia, the pressure at the pressure line increases further. Consequently, the valve body is pushed out of the second closed position further in the direction of the longitudinal axis towards the switch element. If the second throttle gap has moved over the seal, the overflow chamber lies level with the seal in the overpressure position of the pressure shutoff valve. In the overpressure position, the flow connection between the inlet and the outlet of the pressure shutoff valve is produced again, as a result of which the liquid can flow past the seal via the overflow chamber. As a result, overpressures at the pressure line and mechanical load peaks which would act on the entire hydraulic system are dissipated.

The first diameter of the first throttle gap can preferably be smaller than the second diameter of the second throttle gap. Accordingly, in a preferred embodiment of the pressure shutoff valve, the first throttle gap and the second throttle gap have diameters of differing size. The overflow chamber is thus bounded by a first shoulder on the valve housing and a second shoulder on the valve body.

In an alternative configuration of the pressure shutoff valve which is likewise in accordance with the disclosure, the first diameter of the first throttle gap approximately corresponds to the second diameter of the second throttle gap. In this embodiment, the overflow chamber is formed by an undercut between the first throttle gap and the second throttle gap.

It can advantageously be provided that the valve body has a section which is tapered in the direction of the longitudinal axis and which, in the first closed position, is connected to an end of the second throttle gap that faces away from the first throttle gap. The conical section of the valve body means that the seal is not in contact with sharp edges of the valve body, as a result of which the seal is protected when the valve body moves over it.

The valve member of the valve body is in particular conical in the direction of the valve seat of the valve housing. As a result, valve body and valve housing are centred in the closed position.

It can advantageously be provided that the pressure shutoff valve includes a spring element acting on the valve body, wherein the spring element tensions the valve body against the valve seat of the valve housing. The limit pressures at which the pressure shutoff valve takes up the corresponding positions can be defined via the configuration of the spring element.

It can advantageously be provided that the pressure shutoff valve has an open position, a second closed position and an overpressure position, wherein, in the overpressure position, the inlet and the outlet of the valve housing are connected in terms of flow. Via the flow connection between inlet and outlet of the valve housing, pressure between the high-pressure line and the intake line is equalized, as described above, in order to reduce the load peaks in the high-pressure line and at the pump.

It is provided in particular that the pressure shutoff valve is configured in such a manner that, in the event of overpressure at the inlet of the valve housing, the valve body is pressed along the longitudinal axis in a direction away from the inlet, as a result of which the pressure shutoff valve passes from the second closed position into the overpressure position.

Accordingly, the overpressure position follows directly downstream of the second closed position. If the pressure equalization between the high-pressure line and the intake line has taken place, the valve body is pushed back again in the direction of the inlet. The pressure shutoff valve passes here again from the overpressure position into the second closed position.

It can preferably be provided that the pressure shutoff valve has a maximum valve path as measured in the direction of the longitudinal axis and which the valve body covers from the first closed position as far as the overpressure position, and that the valve path of the valve body is smaller than the overall length of the effective throttle gap. This configuration of the pressure shutoff valve makes it unnecessary for the valve body to have to be displaced over the overall length of the effective throttle gap during the transition from the second closed position into the overpressure position. It is already sufficient to displace the valve body in a direction away from the inlet of the valve housing to such an extent that the overflow chamber lies level with the seal, as a result of which a flow connection is produced between inlet and outlet. The maximum valve path is thereby small, as a result of which the construction space of the pressure shutoff valve can be kept compact. The maximum valve path of the valve body preferably corresponds at most to 90%, in particular at most to 80%, preferably to approximately 75% of the overall length of the effective throttle gap.

The valve body can preferably be made of polyoxymethylene (POM). The valve housing can in particular be made of polyoxymethylene (POM). The use of such plastics enables the production costs of the pressure shutoff valve to be reduced.

### BRIEF DESCRIPTION OF THE DRAWINGS

The invention will now be described with reference to the drawings wherein:

FIG. 1 shows a perspective, schematic illustration of a pressure washer;

FIG. 2 shows a perspective, sectioned illustration of the pressure washer with a pressure shutoff valve according to FIG. 1;

FIG. 3 shows a schematic illustration of the operation of the hydraulic unit in a first closed position;

FIG. 4 shows a schematic illustration of the operation of the hydraulic unit in an overpressure position;

FIG. 5 shows a schematic illustration of the operation of the hydraulic unit in a second closed position;

FIG. 6 shows a sectional illustration of the pressure shutoff valve according to the disclosure in a first closed position;

FIG. 7 shows a sectional illustration of the pressure shutoff valve according to FIG. 6 with a pump in the first closed position;

FIG. 8 shows a sectional illustration of the pressure shutoff valve according to FIG. 6 with a pump in the second closed position;

FIG. 9 shows a sectional illustration of the pressure shutoff valve according to FIG. 6 with a pump in the overpressure position; and,

FIG. 10 shows a sectional illustration of a further embodiment of the pressure shutoff valve according to the disclosure with the throttle gaps having identical diameters.

### DESCRIPTION OF THE PREFERRED EMBODIMENTS

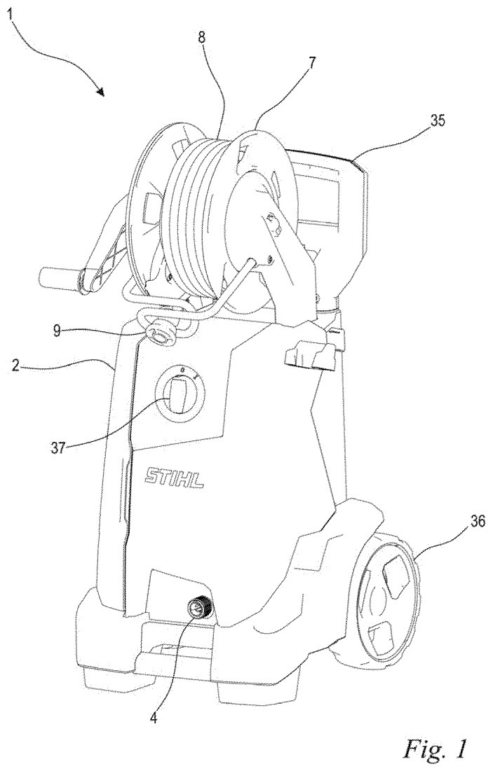

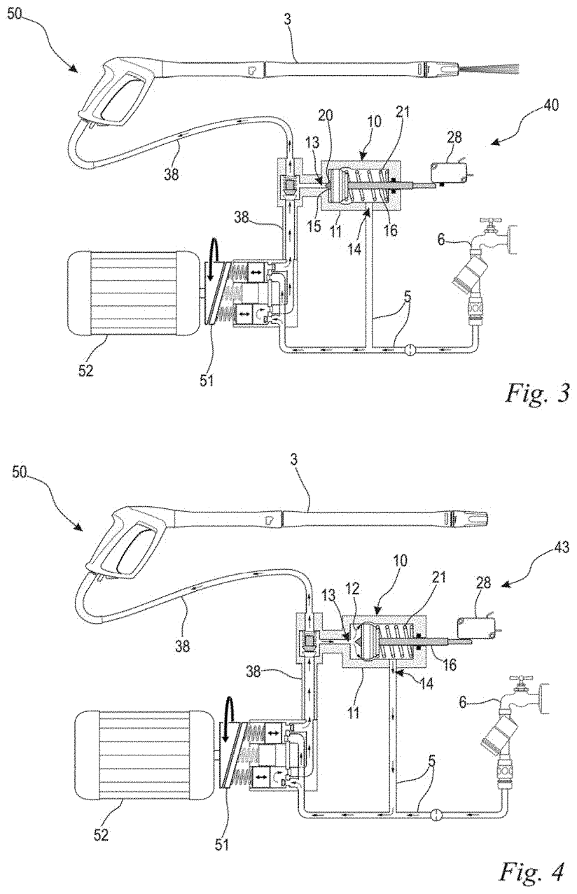

FIG. 1 shows a schematic illustration of an embodiment of the pressure washer 1 according to the disclosure. The pressure washer 1 includes a housing 2 which surrounds individual system components of a hydraulic unit 50 (FIGS. 3 to 5) and protects them, for example, against spray. A low-pressure connection 4 is provided on the housing 2, via which an intake line 5 (FIGS. 3 to 5) of the pressure washer 1 is connectable to an external liquid connection 6 (FIGS. 3 to 5), in particular to a water connection. Accordingly, the pressure washer 1 during its operation is supplied with a cleaning liquid via the low-pressure connection 4. The cleaning liquid is preferably water. Other liquids, for example water mixed with a cleaning agent, may also be provided as cleaning liquid. A hose reel 7 is provided on the housing 2 of the pressure washer 1. A high-pressure hose 8 is wound up on the hose reel 7. The high-pressure hose 8 is connected at its one end to a high-pressure line 38 (FIGS. 3 to 5) of the pressure washer 1. At the other end of the high-pressure hose 8, a pressure connection 9 is provided to which a spray attachment 3 (FIGS. 3 to 5), for example a spray gun with a nozzle head, can be connected.

As shown in FIG. 1, the pressure washer 1 has an operating switch 37, via which the pressure washer 1, in particular the hydraulic unit 50 thereof, can be switched on and off. In addition, a handle 35 is provided on the upper side of the housing 2. By way of its handle 35, the pressure washer 1 can be lifted, in particular carried, or pulled via its wheels 36 arranged on the lower side of the housing 2.

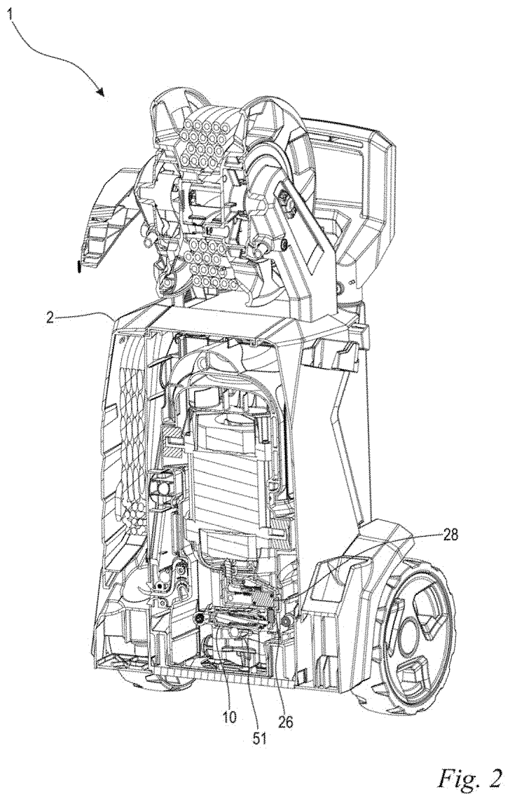

As shown in FIG. 2, the pressure washer 1 has a pump 51 which is driven by a drive motor 52 (FIGS. 3 to 5). In the embodiment, the drive motor 52 is configured as an electric motor. In an alternative embodiment of the pressure washer 1, the drive motor 52 can also be configured as an internal combustion engine. A pressure shutoff valve 10 which, like the pump 51, is part of the hydraulic unit 50 is provided on the pump 51. A switch element 26 and a switch 28 are provided adjacent to the pressure shutoff valve 10. The pressure shutoff valve 10 is operatively connected, preferably mechanically, to the switch 28 via the switch element 26. If the pressure shutoff valve 10 acts on the switch element 26, the latter actuates the switch 28. The switch 28 activates or deactivates the drive motor 52 of the pump 51.

The operation of the hydraulic unit 50 of the pressure washer 1, the hydraulic unit being illustrated schematically in FIGS. 3 to 5, is described below.

The hydraulic unit 50 includes the pump 51 with the drive motor 52, the intake line 5, the high-pressure line 38, the spray attachment 3 and the pressure shutoff valve 10. The intake line 5 is connected to the liquid connection 6 which, in a preferred embodiment, is configured as a water connection. The liquid flows from the liquid connection 6 via the intake line 5 to the pump 51. If the drive motor 52 drives the pump 51, the pump 51 conveys the liquid via the high-pressure line 38 to the spray attachment 3. If the spray attachment 3 is actuated by the operator, the liquid flows at high speed out of the nozzle head of the spray attachment 3. The high-pressure line 38 is connected in terms of flow to the intake line 5 via the pressure shutoff valve 10.

As shown in FIG. 3, the pressure shutoff valve 10 includes a valve housing 11, a valve body 16 which is movable linearly in the valve housing 11, an inlet 13 for supplying liquid and an outlet 14 for removing liquid. The inlet 13 of the pressure shutoff valve 10 is connected to the high-pressure line 38, and the outlet 14 of the pressure shutoff valve 10 is connected to the intake line 5. The pressure shutoff valve 10 has a flow connection 12 (FIG. 4) between the inlet 13 and the outlet 14 of the pressure shutoff valve 10. The pressure shutoff valve 10 includes a valve seat 15 and a valve member 20 assigned to the valve seat 15. In the embodiment, the valve seat 15 is formed on the valve housing 11. The valve member 20 can preferably be formed on the valve body 16. Furthermore, the pressure shutoff valve 10 includes a spring element 21 which acts on the valve body 16 and presses the valve member 20 in the direction of the valve seat 15.

FIG. 3 illustrates the hydraulic unit 50 with an open spray attachment 3. When the spray attachment 3 is open, the pressure in the high-pressure line 38 dissipates. The valve member 20 is pressed onto the valve seat 15 by the spring element 21. The pressure shutoff valve 10 is in a first closed position 40. The valve body 16 releases the switch 28, as a result of which the drive motor 52 of the pump 51 is activated. The liquid is conducted by the pump 51 via the high-pressure line 38 to the nozzle head of the spray attachment 3, from which the liquid emerges at a high speed.

FIG. 4 shows the hydraulic system 50 with a closed spray attachment 3. If the spray attachment 3 is closed while the drive motor 52 is running, an overpressure arises in the high-pressure line 38. At the inlet of the pressure shutoff valve 10, the overpressure brings about a compressive force on the valve body 16, as a result of which the latter is pressed in the direction of the switch 28 counter to the spring force of the spring element 21. The switch 28 is actuated by the valve body 16, as a result of which the drive motor 52 is deactivated. In addition, the overpressure exerts such a high compressive force on the valve body 16 that the latter passes into an overpressure position 43 in which inlet 13 and outlet 14 of the pressure shutoff valve 10 are connected in terms of flow. The pressure between the high-pressure line 38 and the intake line 5 is equalized, thus reducing in particular the mechanical loads which act on the high-pressure line 38, the pump 51 or the high-pressure parts thereof.

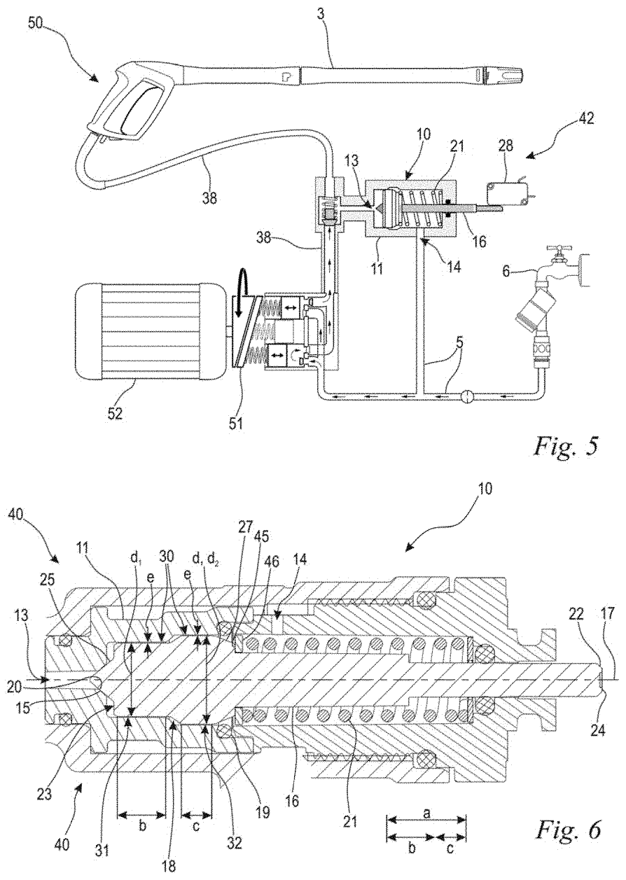

FIG. 5 shows the hydraulic system 50 with a closed spray attachment 3, wherein the pressure shutoff valve 10 is in the second closed position 42 when the drive motor 52 is deactivated. In the second closed position 42, inlet 13 and outlet 14 of the pressure shutoff valve 10 are no longer connected in terms of flow. The pressure still existing at the high-pressure line 38 brings about a compressive force which is in equilibrium with the spring force of the spring element. The spring element 21 is configured here in such a manner that the valve body 16 is deflected such that the flow connection 12 between inlet 13 and outlet 14 of the pressure shutoff valve 10 is interrupted, but the switch 28 is activated by the valve body 16. Only upon activation of the spray attachment 3, as shown in FIG. 3, does the pressure at the high-pressure line 38 again drop sufficiently, as a result of which the valve body 16 moves back into the first closed position 40 and releases the switch 28 again.

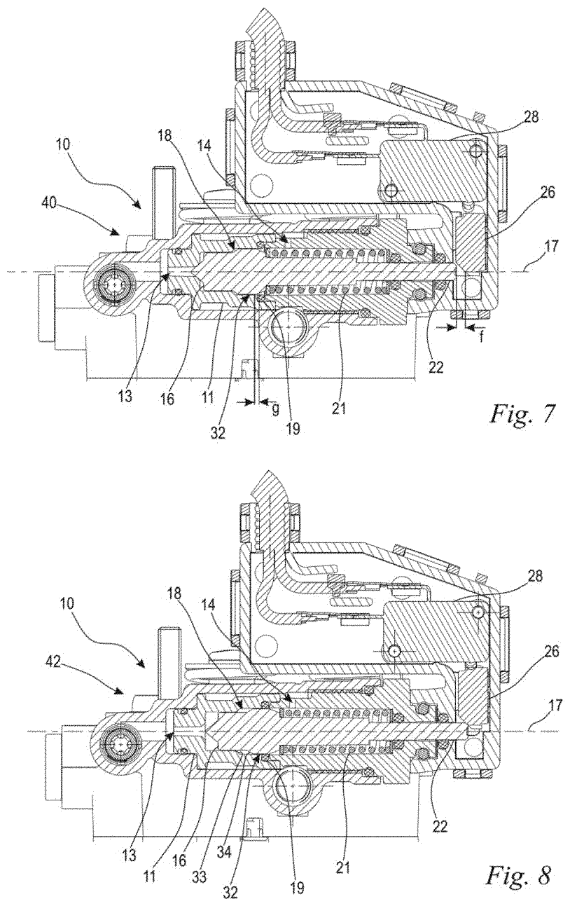

FIG. 6 shows a sectional illustration of the pressure shutoff valve 10 according to the disclosure in the first closed position 40. In a preferred embodiment, the valve body 16 is configured as a piston. The valve body 16 has a longitudinal axis 17 and is mounted movably in the direction of its longitudinal axis 17 in the valve housing 11. The valve body 16 includes a piston head 23 at its end facing the inlet 13 of the pressure shutoff valve 10 and a piston base 22 at its end facing away from the inlet 13 of the pressure shutoff valve 10. The piston base 22 serves to actuate the switch element 26 (FIGS. 7 to 10).

As FIG. 6 shows, the pressure shutoff valve 10 includes a first throttle gap 31 and a second throttle gap 32. The throttle gaps 31, 32 are formed between the valve housing 11 and the valve body 16. The throttle gaps 31, 32 are part of the flow connection 12 and lie between the inlet 13 and the outlet 14 of the pressure shutoff valve 10. The first throttle gap 31 is located upstream preferably closer to the inlet than the second throttle gap 32. The throttle gaps 31, 32 are arranged in a row with respect to each other. The first throttle gap 31 has a gap length b, as measured in the direction of the longitudinal axis 17. The second throttle gap 32 has a gap length c, as measured in the direction of the longitudinal axis 17. The first throttle gap 31 and the second throttle gap 32 together form an effective throttle gap 30. The effective throttle gap 30 has a gap length a, wherein the gap length a corresponds to the sum of the gap length b of the first throttle gap 31 and the gap length c of the second throttle gap 32. The throttle gaps 31, 32 are formed on the piston head 23 of the valve body 16.

As FIG. 6 shows, in a preferred embodiment, the first throttle gap 31 and the second throttle gap 32 merely extend over substantially cylindrical sections of the valve body 16 and of the valve housing 11. For manufacturing reasons, the valve housing 11 has a slight demolding bevel along the throttle gaps 31, 32 in relation to the longitudinal axis 17. Substantially cylindrical should be understood as meaning that the angle enclosed with the longitudinal axis 17 of the valve body 16 is not greater than 2°. The first throttle gap 31 and the second throttle gap 32 each have a gap height e, as measured radially with respect to the longitudinal axis 17. The gap height e corresponds to an average gap height. Accordingly, the gap height is calculated from half the difference of the inner diameter of the valve housing 11 and of the outer diameter of the valve body 16. The diameters should be measured centrally on the throttle gaps 31, 32, as illustrated in FIG. 6. The gap height e of the first throttle gap 31 and of the second throttle gap 32 is preferably smaller than 0.25 mm, in particular smaller than 0.2 mm. The gap height e of the first throttle gap 31 and of the second throttle gap 32 is preferably greater than 0.05 mm, in particular greater than 0.1 mm. In a preferred embodiment, the gap height e of the first throttle gap 31 and of the second throttle gap 32 are identical. In an alternative embodiment, it may be expedient to provide different gap heights e for the throttle gaps 31, 32.

As shown in FIG. 6, the valve body 16 has a maximum diameter d, as measured radially with respect to the longitudinal axis 17. The overall length a of the effective throttle gap 30 is at least 50%, in particular at least 65%, preferably approximately 85% of the maximum diameter d of the valve body 16 in the closed position 40 of the pressure shutoff valve 10. The maximum diameter d of the valve body should preferably be measured merely at one of the throttle gaps 31, 32. The large overall length a of the effective throttle gap 30 means that the flow resistance remains at a sufficiently great level despite the high gap height e of the throttle gaps 31, 32.

As FIG. 6 shows, the first throttle gap 31 has a first diameter d₁, as measured radially with respect to the longitudinal axis 17. The second throttle gap 32 has a second diameter d₂, as measured radially with respect to the longitudinal axis 17. The diameters of the throttle gaps correspond to the outer diameters of the valve body 16 at the respective throttle gaps 31, 32. In the embodiment according to FIG. 6, the diameter d₂ of the second throttle gap 32 is larger than the diameter d₁ of the first throttle gap 31. The different diameters d₁, d₂ of the throttle gaps 31, 32 form an overflow chamber 18 which is provided between the first throttle gap 31 and the second throttle gap 32. The overflow chamber 18 is bounded in the direction of the longitudinal axis 17 at its end facing the inlet 13 by a housing shoulder 33 of the valve housing 11 and at its end facing away from the inlet 13 by a piston shoulder 34 of the valve body (FIG. 8).

As FIG. 6 shows, a section 27 which is tapered with respect to the longitudinal axis 17 in a direction away from the inlet 13 of the pressure shutoff valve 10 is formed on the valve body 16. In the first closed position of the pressure shutoff valve 10, the section 27 adjoins that end of the second throttle gap 32 which faces away from the inlet 13. The tapered section 27 merges into a further piston shoulder 45 of the valve body 16, the piston shoulder extending radially with respect to the longitudinal axis 17. A support ring 46 via which the spring element 21 acts on the valve body 16 is provided on the piston shoulder 45. In the first closed position 40, the spring element 21 clamps the valve body 16 with its conical valve member 20 against the valve seat 21 of the valve housing 11.

As FIG. 6 shows, the pressure shutoff valve 10 includes a sealing ring 19. The sealing ring 19 is preferably held on the valve housing 11. The sealing ring can preferably be configured as an O ring. In the first closed position 40 of the pressure shutoff valve 10, the sealing ring 19 lies in the direction of the longitudinal axis 17 level with the tapered section 27 of the valve body 16. In the first closed position 40, the sealing ring 19 is not in contact with the valve body 16.

In a preferred embodiment, the valve body and/or the valve housing are/is made of plastic, in particular of polyoxymethylene (POM). The large gap height e of the throttle gaps 31, 32 and the overall gap length a of the effective throttle gap 30 permit the use of such materials, as a result of which production costs can be lowered.

The operation of the pressure shutoff valve according to the disclosure is described below with reference to FIGS. 7 to 9:

In FIG. 7, the pressure shutoff valve 10 according to FIG. 6 installed in the pump 51 is shown in its first closed position 40. The valve member 20 of the valve body 16 lies against the valve seat 15 of the valve housing 11. The flow connection 12 between inlet 13 and outlet 14 of the pressure shutoff valve 10 is interrupted. This state is present as described above when the spray attachment 3 is activated and the cleaning liquid flows out of the spray attachment 3. The spring element 21 is configured here in such a manner that, even in the event of pressure fluctuations at the high-pressure line 38, the valve member 20 of the valve body 16 is pressed against the valve seat 15 of the valve housing 11 and the pressure shutoff valve 10 remains in the first closed position 40. Pressure fluctuations of this type can arise, for example, via flow pulses of the pump 51.

As FIG. 7 shows, the valve body 16 does not make contact with the sealing ring 19 in the first closed position 40. If there is a leakage between valve seat 15 and valve member 20, the fluid can flow past the seal 19 via the effective throttle gap 30 from the inlet 13 as far as the outlet 14 of the valve housing 11. The small flows caused by the leakage therefore do not cause any increase in pressure on the inlet side. As a result, an inadvertent switching of the pressure shutoff valve 10 due to leakage is avoided. Such a leakage can arise due to manufacturing tolerances, but also due to wear of valve seat 15 and valve member 20.

If the operator deactivates the spray attachment 3, no more cleaning liquid emerges from the latter. The pump 51 continues to be operated by the drive motor 52, as a result of which the pressure at the high-pressure line 38 rises further. Owing to the increased pressure, a compressive force acts at the outlet 13 on the valve body 16, the compressive force being of such a high level that the valve body 16 is pushed in the direction of its longitudinal axis 17 away from the inlet 13. The valve seat 15 is released from the valve member 20, as a result of which there is a flow connection 12 between the inlet 13 and the outlet 14. The pressure shutoff valve 10 is in an open position 41. However, the flow resistance generated by the effective throttle gap 30 is of such a magnitude that the pressure at the inlet pushes the valve body 16 further away from the inlet 13 counter to the spring force of the spring element 21. The valve body 16 moves from the first closed position 40 as far as the second closed position 42 in which the valve body 16 makes contact with the sealing ring 19. As FIG. 7 shows, the valve body 16 travels here along the closing path g.

As FIG. 8 shows, the valve body 16 has bridged the closing path g and is in contact with the sealing ring 19. The pressure shutoff valve 10 is closed in the second closed position 42 since the sealing ring 19 is in contact with the valve body 16. The pressure at the high-pressure line 38 and/or at the inlet 13 of the valve housing 11 is increased further. Consequently, the compressive force acting on the valve body 16 also increases, as a result of which the valve body 16 is pushed further in the direction of switch element 26. The valve body 16 uses its piston base 22 to actuate the switch element 26 and to press the latter against the switch 28. The switch 28 in turn deactivates the drive motor 52 of the pump 51. The pressure shutoff valve 10 is in the second closed position 42 (FIG. 8).

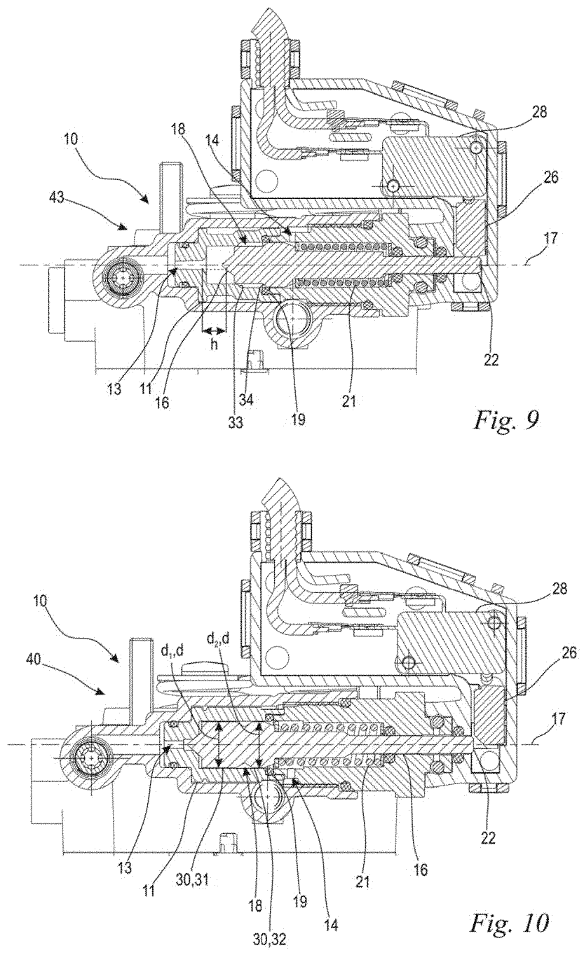

FIG. 9 shows the pressure shutoff valve 10 in its overpressure position 43. As already described above, the pressure between the high-pressure line 38 and the intake line 5 is intended to be equalized in order to reduce the mechanical loads on the system components. After the valve body 16 has actuated the switch element 26, the latter is pressed by the compressive force further in a direction away from the inlet of the pressure shutoff valve 10 until the valve body 16 reaches the overpressure position 43. If the valve body 16 is in the overpressure position 43, the valve body has covered a maximum valve path h, as measured in the direction of the longitudinal axis 17, from the first closed position 40 as far as the overpressure position 43. In the overpressure position 43, the sealing ring 19 is no longer in contact with the valve body 16. In this position of the pressure shutoff valve 10, the overflow chamber 18 is located in the direction of the longitudinal axis 17 level with the sealing ring 19, as a result of which the flow connection 12 is released again. The high-pressure line 38 and the intake line 5 are thereby connected to each other by the pressure shutoff valve 10. Pressure between the high-pressure line 38 and the intake line 5 is equalized. The pressure at the high-pressure line 38 is reduced, as a result of which the compressive force on the valve body 16 is reduced further. The spring element 21 presses the valve body 16 back again in the direction of the inlet 13 until the valve body 16 is in contact again with the sealing ring 19. No further pressure equalization can take place. The valve body 16 remains in the second closed position (FIG. 8) with the drive motor deactivated until operator activates the spray attachment 3 again.

As FIG. 9 shows, the valve path h of the valve body 16 is smaller than the overall length a of the effective throttle gap 30. In a preferred embodiment, the valve path h of the valve body 16 corresponds to less than 90%, in particular to less than 80%, preferably approximately to 75% of the overall length a of the effective throttle gap 30.

FIG. 10 shows a further embodiment of the pressure shutoff valve 10 according to the disclosure. This embodiment differs from the embodiment illustrated in FIGS. 6 to 9 only in the configuration of the diameters d₁, d₂ of the throttle gaps 31, 32. The first diameter d₁ of the first throttle gap 31 corresponds to the second diameter d₂ of the second throttle gap 32. The overflow chamber 18 is formed by an undercut between the first throttle gap 31 and the second throttle gap 32. In the overpressure position 43 of the pressure shutoff valve 10, the overflow chamber 18 permits a flow connection 12 between the inlet 13 and the outlet 14 of the pressure shutoff valve 10. The pressure between the high-pressure line 38 and the intake line 5 can be equalized.

As FIG. 7 shows, the pressure shutoff valve 10 has a switching path f, as measured in the direction of the longitudinal axis 17. The switching path f is the path of the valve body 16 that the valve body 16 has to cover in order to actuate the switch element 26. In other words, the switching path f corresponds to the distance, as measured in the direction of the longitudinal axis 17, between the piston base 22 of the valve body 16 and the switch element 26 along the longitudinal axis 17. The switching path f is preferably shorter than the overall length a of the effective throttle gap 30. The switching path f is at most 50%, in particular at most 35% of the overall length a of the effective throttle gap 30.

It is understood that the foregoing description is that of the preferred embodiments of the invention and that various changes and modifications may be made thereto without departing from the spirit and scope of the invention as defined in the appended claims.

1. A pressure shutoff valve for a pressure washer, the pressure shutoff valve comprising:
a valve housing having a valve seat;
at least one inlet for supplying a liquid;
at least one outlet for removing the liquid;
a valve body defining a longitudinal axis;
said valve body having a valve member assigned to said valve seat, wherein, in a first closed position of the pressure shutoff valve, said valve seat is closed by said valve member and a flow connection between said at least one inlet and said at least one outlet is interrupted;
wherein the pressure shutoff valve has an effective throttle gap between said valve housing and said valve body;
said effective throttle gap having an overall length (a) as measured in a direction of the longitudinal axis of said valve body;
said effective throttle gap being part of said flow connection between said at least one inlet and said at least one outlet;
said valve body having a maximum diameter (d) extending radially with respect to the longitudinal axis; and, said overall length (a) of said effective throttle gap being at least 50% of said maximum diameter (d) of said valve body in the first closed position of the pressure shutoff valve.

2. The pressure shutoff valve of claim 1, wherein said effective throttle gap has a gap height (e), as measured radially with respect to the longitudinal axis of said valve body; and, said gap height (e) is at most 0.25 millimeters.

3. The pressure shutoff valve of claim 1, wherein said effective throttle gap has a gap height (e), as measured radially with respect to the longitudinal axis of said valve body; and, said gap height (e) is at most 0.2 millimeters.

4. The pressure shutoff valve of claim 1, wherein said effective throttle gap includes a first throttle gap having a first diameter (d₁) and a second throttle gap having a second diameter (d₂).

5. The pressure shutoff valve of claim 4, wherein, between said first throttle gap and said second throttle gap, an overflow chamber is defined between said valve body and said valve housing.

6. The pressure shutoff valve of claim 4, wherein said first diameter (d₁) of said first throttle gap is smaller than said second diameter (d₂) of said second throttle gap.

7. The pressure shutoff valve of claim 4, wherein said first diameter (d₁) of said first throttle gap corresponds to said second diameter (d₂) of said second throttle gap.

8. The pressure shutoff valve of claim 4, wherein said valve body has a tapered section tapered in the direction of the longitudinal axis; and, said second throttle gap has an end which faces away from said first throttle gap and which is adjoined by said tapered section of said valve body.

9. The pressure shutoff valve of claim 1, wherein said valve member of said valve body is conical in a direction of said valve seat of said valve housing.

10. The pressure shutoff valve of claim 1 further comprising:
a spring element acting on said valve body; and, said spring element being configured to tension said valve body against said valve seat of said valve housing.

11. The pressure shutoff valve of claim 1, wherein the pressure shutoff valve has an open position, a second closed position, and an overpressure position; and, said inlet and said outlet are connected in terms of flow in said overpressure position.

12. The pressure shutoff valve of claim 11, wherein the pressure shutoff valve is configured in such a manner that, in an event of overpressure at said inlet of said valve housing, said valve body is pressed along the longitudinal axis in a direction away from said inlet, as a result of which the pressure shutoff valve passes from said second closed position into said overpressure position.

13. The pressure shutoff valve of claim 11, wherein the pressure shutoff valve has a maximum valve path (h) as measured in the direction of the longitudinal axis; said valve body covers said maximum valve path (h) from said first closed position as far as the overpressure position; and, said maximum valve path (h) of said valve body is smaller than said overall length (a) of said effective throttle gap.

14. The pressure shutoff valve of claim 13, wherein said valve path (h) of said valve body corresponds at most to 90% of said overall length (a) of said effective throttle gap.

15. The pressure shutoff valve of claim 13, wherein said valve path (h) of said valve body corresponds at most to 80% of said overall length (a) of said effective throttle gap.

16. The pressure shutoff valve of claim 13, wherein said valve path (h) of said valve body corresponds at most to 75% of said overall length (a) of said effective throttle gap.

17. Pressure shutoff valve of claim 1, wherein at least one of said valve body and said valve housing are made of polyoxymethylene (POM).

18. A pressure washer comprising:
a pressure shutoff valve including a valve housing having a valve seat;
said pressure shutoff valve having at least one inlet for supplying a liquid and at least one outlet for removing the liquid;
said pressure shutoff valve further having a valve body defining a longitudinal axis;
said valve body having a valve member assigned to said valve seat, wherein, in a first closed position of said pressure shutoff valve, said valve seat is closed by said valve member and a flow connection between said at least one inlet and said at least one outlet is interrupted;
said pressure shutoff valve having an effective throttle gap between said valve housing and said valve body;
said effective throttle gap having an overall length (a) as measured in a direction of the longitudinal axis of said valve body;
said effective throttle gap being part of said flow connection between said at least one inlet and said at least one outlet;
said valve body having a maximum diameter (d) extending radially with respect to the longitudinal axis; and, said overall length (a) of said effective throttle gap being at least 50% of said maximum diameter (d) of said valve body in said first closed position of said pressure shutoff valve.
